(19) United States
(12) Patent Application Publication
(10) Pub. No.: US 2016/0237264 A1
(43) Pub. Date: Aug. 18, 2016

(54) Alkylphenol-free Polymeric Polyphosphite Stabilizer for Polyolefin Compositions for Film, Fiber and Molded Articles

(71) Applicant: Dover Chemical Corporation, Dover, OH (US)

(72) Inventors: Michael R. Jakupca, Canton, OH (US); Jacob M. Lance, New Philadelphia, OH (US); Donald Stevenson, Dover, OH (US); John T. Regula, Baltic, OH (US); Jacob J. Weingart, Canton, OH (US)

(73) Assignee: Dover Chemical Corporation, Dover, OH (US)

(21) Appl. No.: 15/138,834

(22) Filed: Apr. 26, 2016

(51) Int. Cl. C08L 23/06

(52) U.S. Cl. CPC C08L 23/06

(57) ABSTRACT

The invention pertains generally to an improved polymer composition which contains at least one liquid polymeric polyphosphite additive containing no alkylphenols. Alkylphenol-free polymeric polyphosphites offer distinct advantages over conventional phosphite technology in polyolefin films. Polymeric polyphosphites offer improved performance in regards to the prevention of color formation during high temperature processing, NOx aging, and gamma irradiation.

### TECHNICAL FIELD

The invention described herein pertains generally to a synergistic combination of alkylphenol-free polymeric polyphosphites and polymeric copolyphosphites having improved properties.

### BACKGROUND OF THE INVENTION

At least one purpose associated with the addition of a stabilizer to a polymeric resin is to prevent deterioration of the polymers derived from the resin during processing at high temperatures and also to permit the manufacture of products with increased intrinsic quality attributable at least in part to increased resistance to thermal and light degradation during their intended use.

Many organic phosphites have been used as stabilizers, and most are based on alkylphenols. Among them are the commercially significant phosphites, tris (nonylphenyl) phosphite (TNPP) and tris (2, 4-di-t-butylphenyl) (TTBP) phosphite. Historically, TNPP has been the primary low cost liquid phosphite stabilizer used in the plastic and rubber industry. Recently, however, plastic and rubber manufactures have been reluctant to use TNPP in their formulation due to concerns that one of the degradation products of TNPP (nonylphenol) may be xenoestrogenic.

Due to this concern about alkylphenols, it is advantageous to use a phosphite containing no alkylphenols. U.S. Pat. No. 8,563,637, U.S. Pat. No. 8,981,042, US published patent application US 2014/0378590 and US published patent application US2013/0190434 as well as applications claiming priority thereto and therefrom, all disclose liquid polymeric polyphosphites, that are good polymer stabilizers and do not contain any alkylphenols. Such liquid polymeric polyphosphites are unique since they have very low migration from polymer films, are good color stabilizers for polymers, exhibit good color stability for gamma irradiation of polymers, and in general are a good overall stabilizer for polymers especially LLDPE and all polyolefins. This invention will illustrate novel blends of the polymeric polyphosphites with hindered phenols, (especially Vitamin E), other phosphites and with other stabilizers that show superior performance in stabilizing polymers compared with prior phosphite/hindered phenol blends.

It has been found that using these polymeric phosphites containing no alkylphenols has some unexpected performance benefits in polyolefins, especially polyolefin films. These phosphites offer superior color protection during high temperature processing, long term heat aging, and NOx aging. In addition to these color benefits it provides superior protection against gel formation in films.

The polymeric phosphites compositions of the above mentioned patents and patent applications offer a unique synergy with vitamin E in the stabilization of polyolefins. Vitamin E is well known to be an excellent polymer stabilizer in terms of melt index (“MI”) control. It is such an effective stabilizer that it can often be used at a fraction of the loading level of commodity phenolic antioxidants. However it is known to impart a high amount of color to the polymer when used with conventional alklyphenol based phosphites which has greatly limited its commercial use. The combination of vitamin E with the alkylphenol-free polyphosphites described herein impart excellent MI and color stability to the polymer.

Another advantage of these polymeric phosphites is their compatibility with the polymer. Solid phosphites such as tris (2, 4-di-t-butylphenyl) phosphite are also every effective stabilizers in polyolefins but they often have compatibility issues, especially in film applications. When solid phosphites are used at too high of a loading level, the phosphite may deposit onto the processing equipment causing costly delays in production due to equipment cleaning. The phosphite may also exude out of the polymer during storage or during its end use causing a powder to form on the surface of the polymer. The liquid phosphites of the current invention are compatible in polyolefins and do not have the exudation problem associated with solid phosphites.

### SUMMARY OF THE INVENTION

The present invention is directed to novel liquid polymeric polyphosphites of the general structure I as stabilizers for polymers during processing.

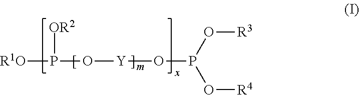

wherein
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group.

The present invention is also directed to novel copolymeric polyphosphites of the general structure II as stabilizers for polymers during processing.

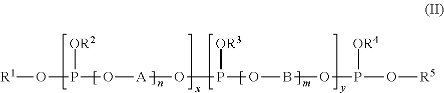

wherein
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group.

The present invention is also directed to the novel cycloaliphatic polyphosphite and copolyphosphites of U.S. Pat. No. 8,981,042 and patent application US 2014/0378590 and have the general Structure Ill.

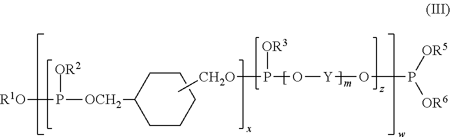

where each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
   z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000.

The novel, linear polymeric phosphites of the general Structures I or II or Ill, as disclosed in above referenced patents and patent applications are especially suitable for stabilization of films of polyolefins. The advantages of the liquid high molecule weight polymeric phosphites are very low volatility, low migration out of the polymer being stabilized, low gel counts in the polymer, and improved resistance to NOx gas. These advantages can translate into desirable properties of the polyolefin film.

This invention therefore relates to a composition that is prepared by processing a polyolefin with one of the polymeric phosphites disclosed in the above patents and the process for preparing a film or molded articles from said composition. The polymeric phosphite may be used on its own or in combination with other antioxidants and polymer additives.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein

FIG. 1 is a graph of Yellowness Index vs. Days in a NOx chamber at 50° C.;

FIG. 2 is a bar graph of days to failure at 150° C.;

FIG. 3 is a graph of initial color measured by the Yellowness Index as contrasted to color at day 12 as measured by the Yellowness Index;

FIG. 4 is a bar graph of gel counts of two phosphites;

FIG. 5 is a graph of melt flow index over extrusion pass;

FIG. 6 is a is a graph of Yellowness Index over extrusion pass;

FIG. 7 is a is a bar graph of Yellowness Index before and after gamma irradiation;

FIG. 8 is a graph of surface glass over days in an oven at 70° C.;

FIG. 9 is a graph of compatibility of various phosphites in linear low density polyethylene; and

FIG. 10 is a graph of compatibility of a blend of solid phosphites in linear low density polyethylene.

### DETAILED DESCRIPTION OF THE INVENTION

The best mode for carrying out the invention will now be described for the purposes of illustrating the best mode known to the applicant at the time of the filing of this invention. The examples and figures are illustrative only and not meant to limit the invention, as measured by the scope and spirit of the claims.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

As used in this application, the term “approximately” is within 10% of the stated value, except where noted.

The invention provides for an improved stabilized polyolefin composition prepared by a standard polyolefin processing process such as extruding to produce a film. The polyolefin film may be any of the commercially produced film types such as blown film or cast film

Polyolefin films may be produced from the polymers described below.

Polymers of monoolefins and diolefins such as polyethylene, polypropylene, polyoisobutylene, poly-1-butene, poly-4-methylpentene, polyisoprene, polybutadiene, for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), and polymers of cycloolefins such as cyclopentene and norbornene, and blends of the polymers described above.

Copolymers of monoolefins and diolefins with each other or with other vinyl monomers such as ethylene/propylene, propylene/1-butene, propylene/isobutene, propylene/butadiene, ethylene/1-butene, ethylene/1-hexene, ethylene/1-octene, isobutylene/isoprene, ethylene/alkylacrylates, ethylene/alkylmethacrylates, ethylene/vinyl acetate, ethylene/acrylic acid (and salts, ionomers, thereof), terpolymers of ethylene, propylene, and dienes such as hexadiene, dicyclopentadiene, and ethylene-norbornene.

In general the polymeric phosphites of this invention are added to the organic material to be stabilized in amounts from about 0.001 wt % to about 5 wt % of the weight of the organic material to be stabilized. A more preferred range is from about 0.01% to 2.0%. The most preferred range is from 0.025% to 1%.

The stabilizers of this invention may be incorporated into the organic materials at any convenient stage prior to manufacture of the film using techniques known in the art.

The stabilized polymer compositions of the invention may also contain from about 0.001% to 5%, preferably from 0.01% to 2%, and most preferably from 0.025% to 1% of other conventional stabilizers listed below or in Chemical Additives for the Plastic Industry, by Radian Corporation, Noyes Data Corporation NJ, published 1987, hereafter referred to as Chemical Additives.

Hindered phenolic antioxidants such as 2,6-di-tert-butyl-4-methylphenol; octadecyl 3,5-di-tert-butyl-4-hydroxy-hydrocinnamate; tetrakis methylene (3,5-di-tert-butyl-4-hydroxyhydrocinnamate)methane; and tris(3,5-di-tert-butyl-4-hydroxybenzyl) isocyanate. Other phenolic antioxidants are listed in Chemical Additives, pages 152 to 163.

Thioesters such as dilauryl thiodipropionate and distearyl thiodipropionate. Other thioesters are listed in Chemical Additives, page 152 to 163.

Aromatic amine stabilizers such as N, N′-diphenyl-p-phenylene-diamine. Other aromatic amine stabilizers are listed in Chemical Additives, pages 152 to 163.

Hindered amine light stabilizers, known as HALS, such as bis-(2,2,6,6-tetramethylpiperidyl) sebacate, condensation product of N,N′-(2,2,6.6-tetramethylpiperidyl)-hexamethylenediamine and 4,4-octylamino-2,6-dichloro-s-triazine, and the condensation product of N,N′-(2,2,6.6-tetramethylpiperidyl)-hexamethylenediamine and 4-N-morpholinyl-2,6-dichloro-s-triazine. Other HALS are listed in Chemical Additives, pages 660-666.

UV absorbers such as 2-hydroxy-4-n-octyloxybenzophenone, 2(2′-hydroxy-5′-methylphenyl)-benzotriazole, and 2(2′-hydroxy-5-t-octylphenyl)-benzotriazole. Other UV stabilizers are listed in Chemical Additives, pages 660-666.

Phosphites such as tris(2,4-di-tert-butylphenyl)phosphite, distearyl pentaerythritol diphosphite, and 2,4-dicumylphenyl pentaerythritol diphosphite. Other phosphites are listed in Chemical Additives, pages 152 to 163.

Acid neutralizers such as calcium stearate, zinc stearate, calcium lactate, calcium stearyl lactate, epoxidized soybean oil, and hydrotalcite (natural and synthetic).

Other additives such as lubricants, antistatic agents, antiblocking agents, slip agents, fire retardants, nucleating agents, impact modifiers, blowing agents, plasticizers, fillers, dyes, and pigments may be used in an amount appropriate and in combination of the invented polymeric phosphites to modify a selected property of the polymer. These and other additives can be found listed in Chemical Additives.

Alkanol amines such as but not limited to triethanolamine and triisopropanolamine.

The novel, linear, polymeric phosphites of the structure IV can be used in particular with combination of phenolic antioxidants, light stabilizers and/or processing stabilizers.

The liquid polymeric phosphites of this invention are generally much more compatible with the polyolefin polymer than other commercially available mono-phosphites such as tris(2,4-di-t-buytlyphenol)phosphite (TTBP) and tris(nonylphenol)phosphite (TNPP). The high molecular weight and the improved compatibility offers several distinct advantages over traditional monophosphites or diphosphites. Solid phosphites such as TTBP are known to exude from the polymer film and must be used at lower concentrations to minimize buildup on processing equipment. Additionally such solid monophosphites may exude to the surface of the polymer post-processing forming a layer of dust on the surface of the film.

Liquid mono-phosphites such as TNPP do not typically exude from the polymer during processing or post processing. However it is still desirable to have a more compatible polymeric phosphite since much of the polyolefin film produced is used for food packaging where the film may come into direct contact with food. It is known that whatever additives are contained in the polymer film have the potential to migrate from the polymer into the food it is in contact with. The polymeric polyphosphites of this invention exhibit far lower migration when in contact with food due to their high molecular weight.

Polyolefin film compositions containing the polymeric polyphosphites also exhibit improved color stabilization in comparison to TNPP and TTBP. This is evident during melt processing as well as post processing. During melt processing the color, as measured by the Yellowness Index (YI) of the polymer may increase from the shear and heat degradation do to the extrusion or film production process. The polymeric polyphosphites produce a polyolefin film of lower color (YI) when used at equal loading levels or even when used at lower loading levels.

There are many conditions post processing that the polyolefin film may be exposed to that has the potential to increase the color of the polymer. Polyolefin films may be exposed to NOx gases which are highly oxidative. Alkylphenols are oxidized by these gases forming color bodies in the polymer. Phosphites such as TNPP and TTBP are produced from alkylphenols and therefore contribute to the color increase of a polyolefin film exposed to these gases. Since the polymeric polyphosphites of the current invention contain no alkylphenols, they do not contribute to the color increase thereby producing a film with lower color.

Polyolefin films may also be subject to gamma irradiation in medical applications to sterilize a medical device. The gamma irradiation can also decompose any alkylphenol groups in the polymer causing an increase in color. The polymer phosphites of this invention show far superior color hold when exposed to gamma irradiation since they are not composed of any alkylphenols.

Polyolefin films can also be exposed to elevated temperatures post processing. The elevated temperatures are very degradative to the polymer causing both color increase and loss of the polymers mechanical properties. The polymeric phosphites offer equal or slightly better against the loss of mechanical properties and far superior protection against color increase.

During film processing it is common for small gels to form due to crosslinking of the polyolefin. The polymeric polyphosphites of this invention offer improved protection against the formation of these gels when compared to TNPP or TTBP.

Additionally the polymeric phosphites of the current invention offer a synergy with tocophenols (Vitamin E) when used in combination to stabilize a polymer. It is known in the art that Vitamin E is an excellent polymer stabilizer that can be used at a fraction of the loading level of many hindered phenol stabilizers. However it is not commonly used as a stabilizer in polyolefin films since it has the tendency to cause greatly increased color when used with traditional phosphites like TNPP and TTBP. The polymeric phosphites of this invention offer such improved color stability that they can be used with Vitamin E to produce a film with better color than traditional antioxidant packages using hindered phenols and TNPP or TTBP.

The Vitamin E polymeric polyphosphite combinations are especially beneficial for protection against gas fade since the hindered phenolic may also contribute to color formation. This unique combination of Vitamin E and the polymeric polyphosphite can be used to make a polyolefin film composition that is essentially completely resistant to gas fade.

The invention will now be described by a series of examples.

### Example 1

PPG 400 (95 g, 0.237 mol), triphenyl phosphite (73 g, 0.235 mol), a mixture of lauryl and myristyl alcohol with a hydroxyl number of about 280, (47 g, 0.235 mol), and 0.8 grams of potassium hydroxide were added together. The mixture was mixed well and heated to 160-162° C. under nitrogen and held at the temperature for 1 hour. The pressure was then gradually reduced to 0.3 mmHg and the temperature was increased to 170-172° C. over a course of 1 hour. The reaction contents were held at 170-172° C. under the vacuum for 2 hours at which point no more phenol was distilling out. The vacuum was then broken by nitrogen and the crude product was cooled to 50° C. The product was a clear, colorless liquid.

### Example 2

PPG 400 (48 g, 0.12 mol), triphenyl phosphite (73 g, 0.235 mol), lauryl alcohol, (47 g, 0.235 mol), dipropylene glycol (16 g 0.12 mol) and 0.8 grams of potassium hydroxide were added together. The mixture was mixed well and heated to 160-162° C. under nitrogen and held at the temperature for 1 hour. The pressure was then gradually reduced to 0.3 mmHg and the temperature was increased to 170-172° C. over a course of 1 hour. The reaction contents were held at 170-172° C. under the vacuum for 2 hours at which point no more phenol was distilling out. The vacuum was then broken by nitrogen and the crude product was cooled to 50° C. The product was a clear, colorless liquid.

### Example 3

1,6 hexane diol (57 g, 0.48 mol), triphenyl phosphite (150 g, 0.48 mol), a mixture of lauryl and myristyl alcohol with a hydroxyl number of about 280, (97 g, 0.48 mol), and 0.8 grams of potassium hydroxide were added together. The mixture was mixed well and heated to 160-162° C. under nitrogen and held at the temperature for 1 hour. The pressure was then gradually reduced to 0.3 mmHg and the temperature was increased to 170-172° C. over a course of 1 hour. The reaction contents were held at 170-172° C. under the vacuum for 2 hours at which point no more phenol was distilling out. The vacuum was then broken by nitrogen and the crude product was cooled to 50° C. The product was a hazy, colorless liquid.

### Example 4

The apparatus in Example #1 was used. 100 grams (0.69 mol) of cyclohexane dimethanol, triphenyl phosphite (237 g, 0.76 mol), a mixture of lauryl and myristyl alcohol with a hydroxyl number of about 280, (190 g, 0.95 mol), and 0.4 grams of potassium hydroxide were added. The mixture was mixed well and heated to approximately 150° C. under nitrogen and held at the temperature for 1 hour. The pressure was then gradually reduced to 0.3 mm Hg and the temperature was increased to 180° C. over a course of 1 hour. The reaction contents were held at 180° C. under the vacuum for 2 hours at which point no more phenol was distilling out. The vacuum was then broken by nitrogen and the crude product was cooled to ambient temperature. The product was a non viscous liquid.

### Example 5

The apparatus in Example #1 was used. 20 grams (0.14 mol) of cyclohexane dimethanol, 7 g polypropylene glycol 400 (0.02 m), triphenyl phosphite (100 g, 0.32 mol), a mixture of lauryl and myristyl alcohol with a hydroxyl number of about 280 (136 g, 0.69 mol) and 0.4 grams of potassium hydroxide were added. The mixture was mixed well and heated to approximately 150° C. under nitrogen and held at the temperature for 1 hour. The pressure was then gradually reduced to 0.3 mm Hg and the temperature was increased to 180° C. over a course of 1 hour. The reaction contents were held at 180° C. under the vacuum for 2 hours at which point no more phenol was distilling out. The vacuum was then broken by nitrogen and the crude product was cooled to ambient temperature. The product was a non viscous liquid.

Characteristics of the various synthesized additives may be characterized at least in part by the following tables.

TABLE I

| | Example | | | | |
|---|---|---|---|---|---|
| | #1 | #2 | #3 | #4 | #5 |
| appearance | liquid | liquid. | liquid. | liquid | liquid. |
| Acid Value (“AV”) (initial) | 0.01 | 0.05 | 0.01 | 0.01 | 0.01 |
| % P | 4.9 | 5.9 | 8.9 | 7.6 | 6.0 |
| Avg. MW | 9,111 | 7,250 | 31,515 | 13,957 | 1,651 |

The following examples are meant to illustrate the benefits of the current invention over convential phosphites. They are not intended to cover every single application which these could be used.

### Example 6

### NOx Oven Aging

NOx gases are known to have oxidative effects on polymers and often cause color issues in polymers exposed to them. Alkylphenols such as those found in many phosphite stabilizers may also oxidize when exposed to these gases and form color bodies in the polymer contributing to the color problem. Commonly used phenolic primary antioxidants typically oxidize causing color bodies in the polymer.

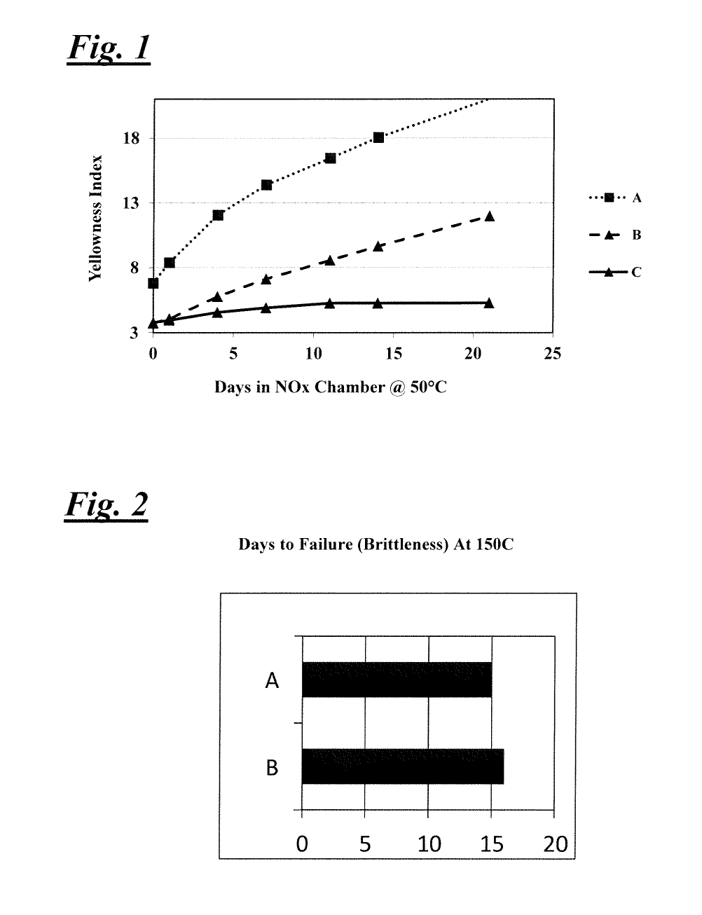

The desired additives were compounded into LLDPE and exposed to NOx gases at 50° C. for 3 weeks. The color values (YI) were measured at the beginning of the experiment and then incrementally over the course of the 3 week period. (See FIG. 1)

The phosphites of the current invention show a marked improvement in color hold in comparison to an alklyphenol containing phosphite such as TNPP. This shows the superiority of the phosphites of the current invention over alklyphenol containing phosphites. The synergy of the current invention with Vitamin E is also illustrated as shown by the improvement in the color over standard primary antioxidant as illustrated in Table II.

TABLE II

| | Primary Antioxidant | Phosphite |
|---|---|---|
| A | 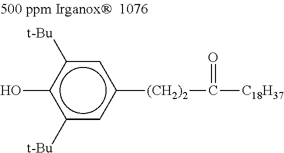 | 1500 ppm TNPP |
| B | 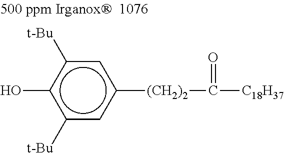 | 1500 ppm polymeric polyphosphite (Example #1) |
| C | 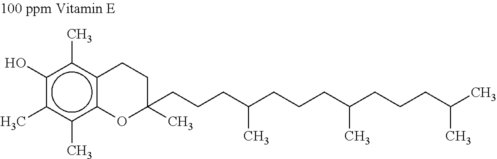 | 1500 ppm polymeric polyphosphite (Example #1) |

As illustrated above, the use of a polymeric polyphosphite (e.g., Example #1) in combination with a primary antioxidant, either Irganox® 1076 or Vitamin E, made films which when exposed to NOx, enables the films to resist yellowing for longer periods of time when contrasted to standard phosphites such as TNPP.

### Example 7

### Long Term Heat Aging

Long term heat aging is another important aspect of polymer stability in which the phosphite plays an important role. At times polymers may be exposed to elevated temperatures for extended periods of time and need to retain their properties. Experiments were carried out in polypropylene (see Table III) to compare the stability imparted by tris-2,4 di-tert-butyphenol phosphite (Irgafos® 168) to polymeric polyphosphites when used with a primary antioxidant, namely Irganox® 1010 (pentaerythritol tetrakis(3-(3,5-di-tert-butyl-4-hydroxyphenyl)propionate). The phosphites and other additives were compounded into the polypropylene and then compression molded into plaques. It was noted that the combination of the polymeric CHDM polyphosphite of Example #4 in combination with the primary antioxidant Irganox® 1010 performed better than the more traditional combination of Irganox® 1010 with Irgafos® 168. (See FIG. 3)

TABLE III

| Formulation | Primary Antioxidant | Phosphite | Acid Scavenger |
|---|---|---|---|
| A | 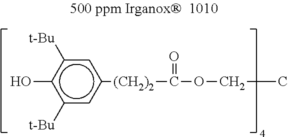 | 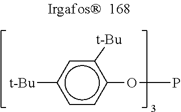 | 500 ppm calcium stearate |
| B | 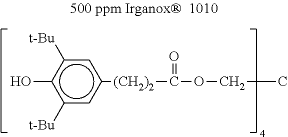 | polymeric polyphosphite (Example #4) | 500 ppm calcium stearate |

The plaques were aged in a 150° C. oven until the polymer samples began to crack and break apart. Color YI was also measured at day 12 in the study. The polymeric polyphosphites maintain the polypropylene properties for slightly longer extending the time until the polymer becomes brittle. Color stability of the polymeric phosphites is far superior to that of the conventional phosphites containing alkylphenols. (see FIG. 2)

### Example 8

### Gel Counts

Gel formation in polyolefin films is an important measurement of the polymers stability. Gel formation indicates the polymer is degrading and crosslinking. Phosphites offer protection against the formation of gels.

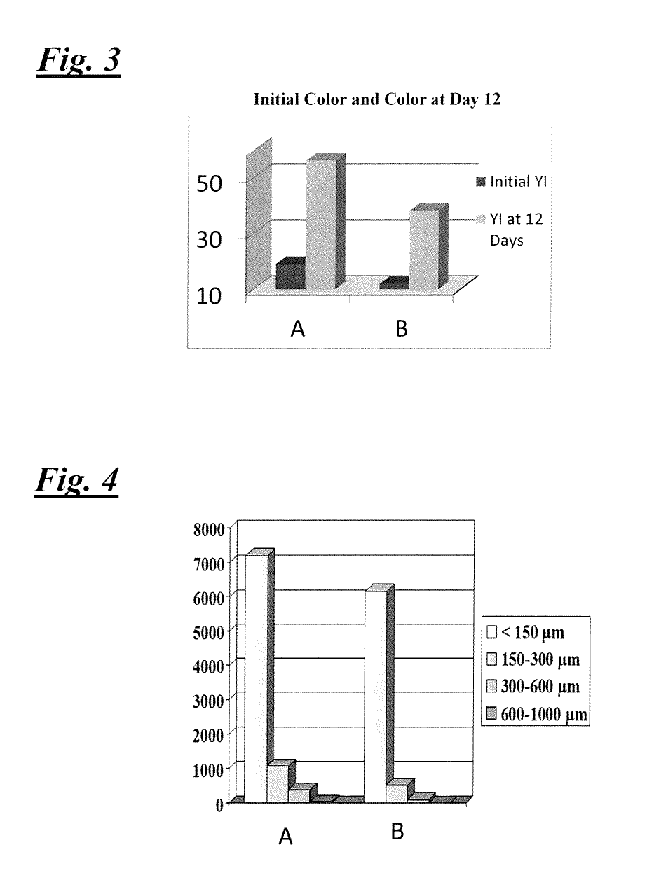

Tris-nonylphenol phosphite and a polymeric polyphosphite were compounded into linear low density polyethylene at 800 ppm with a primary antioxidant. Cast film was produced from the LLDPE and gel counts were measured at various sizes determine the effectiveness of the phosphite at preventing gel formation. The cast film stabilized by the polymeric polyphosphite had lower levels of gels in all of the size ranges indicating superior stabilization against polymer degradation. The combination of the polymeric polyphosphite (Example #1) with that of Irganox® 1076 performed better than the traditional combination of TNPP with Irganox® 1076. (See Table IV & FIG. 4)

TABLE IV

| Formulation | Primary Antioxidant | Phosphite |
|---|---|---|
| A | 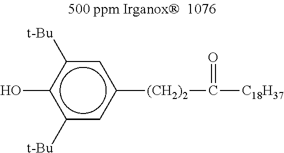 | 800 ppm TNPP |
| B | 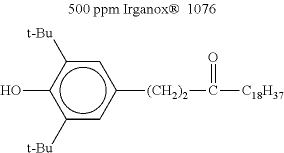 | 800 ppm polymeric polyphosphite, (Example #1) |

### Example 9

### Synergy with Vitamin E

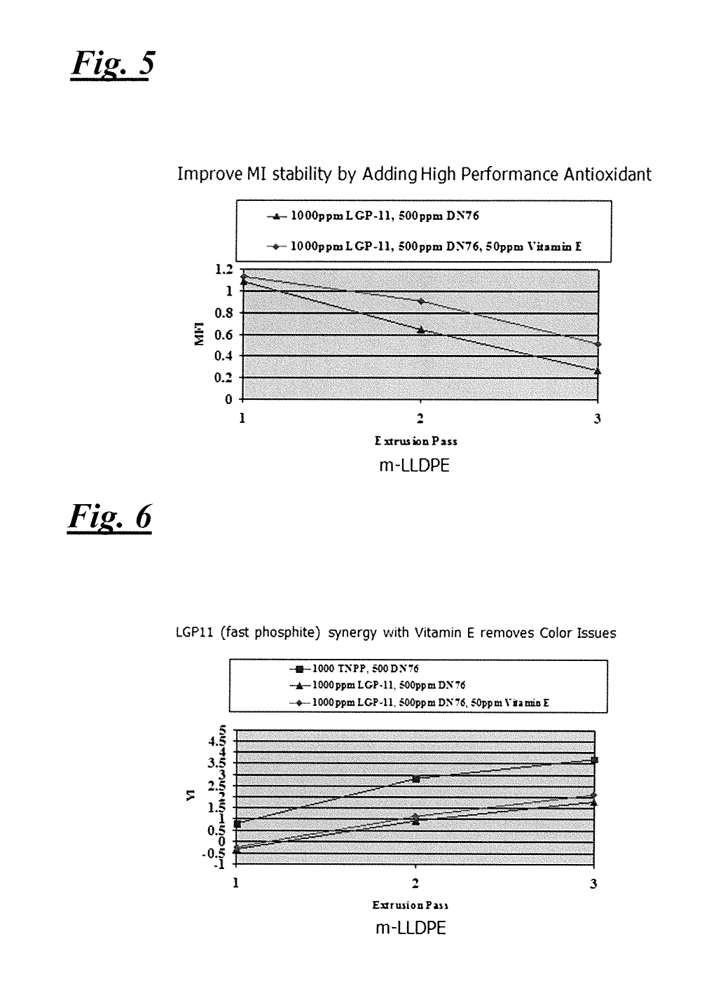

Another way to improve melt processing is to use higher performance antioxidants. Phosphites improved the melt index with increased % phosphorus, or increasing the primary antioxidant. Phosphites also improve color. Improved melt processing can also be improved by adding or change to higher performance antioxidants such as carbon radical scavengers (Vitamin E). But Vitamin E when used with standard phosphites, gives darker colors. Polymeric polyphosphites (example #1) overcome the color issues associated with Vitamin E. The polyphosphite (example #1) prevents the over-oxidation of Vitamin E (as well as other primary antioxidants) which leads to better color. Vitamin E is soluble in example #1 and the other polyphosphites of this invention, and the blend offers both excellent color and melt index control. (See Table II and FIG. 5 which illustrates the improved melt stability by adding a high performance polyphosphite antioxidant with Dovernox® 76 (octadecyl 3,5-di-t-butyl-4-hydroxyhydrocinnamate) and Vitamin E and FIG. 6 which illustrates the synergy of improved YI over extrusion passes when using a high performance polyphosphite antioxidant with Dovernox® 76 and Vitamin E)

### Example 10

### Migration from Polymer

Polyolefins are often used in food packaging applications. Additives contained in the polyolefins have the potential to migrate out of the polymer packaging and into the food. Small molecules are more prone to migration than larger molecules therefore exposing the public to higher levels of the additives. Since the phosphites of the current invention are polymeric the amount of migration out of the polymer and into food is significantly lower than standard phosphites such as tris-nonylphenol phosphite (known as TNPP) and tris-di-tertbutylphenol phosphite, (commonly known as Irgafos® 168 or Doverphos® 480).

Migration experiments were carried out in 95% ethanol which is considered a fatty food simulant by the FDA. This is generally the most severe type of food simulant causing the highest amount of migration for polymer additives. The additives were compounded into LLDPE, compression molded into 20 mill inch thick sheets, and then cut into discs. The polymer discs containing the additives were submerged in 95% ethanol and heated at 70° C. for 2 hours. The ethanol solutions were then analyzed to determine the amount of migration out of the polymer into the food simulant. The ppm in food was calculated according to the FDA's guidelines.

Due to the much higher molecular weight of the polymeric phosphites, the migration levels into the food simulant was much lower, thereby lowering the exposure of the public to this additive when used in food packaging applications as shown in Table V.

TABLE V

| Formulation in LLDPE | PPMs in Food |
|---|---|
| 1000 ppm tris-nonylphenol phosphite | 5.9 |
| 1000 ppm tris-2,4 di-tert-butylphenol phosphite | 5.2 |
| 1000 ppm polymeric polyphosphite (Example #1) | <0.5 |

### Example 11

### Gamma Irradiation

Gamma irradiation is a process commonly used to sterilize medical devices. This intense radiation can cause degradation of any additives containing an aromatic group. These aromatic groups can then be further oxidized to produce color in the polymer. The phosphites of the current invention do not contain any aromatic groups and therefore do not degrade under gamma irradiation thereby not increasing the color of the polymer.

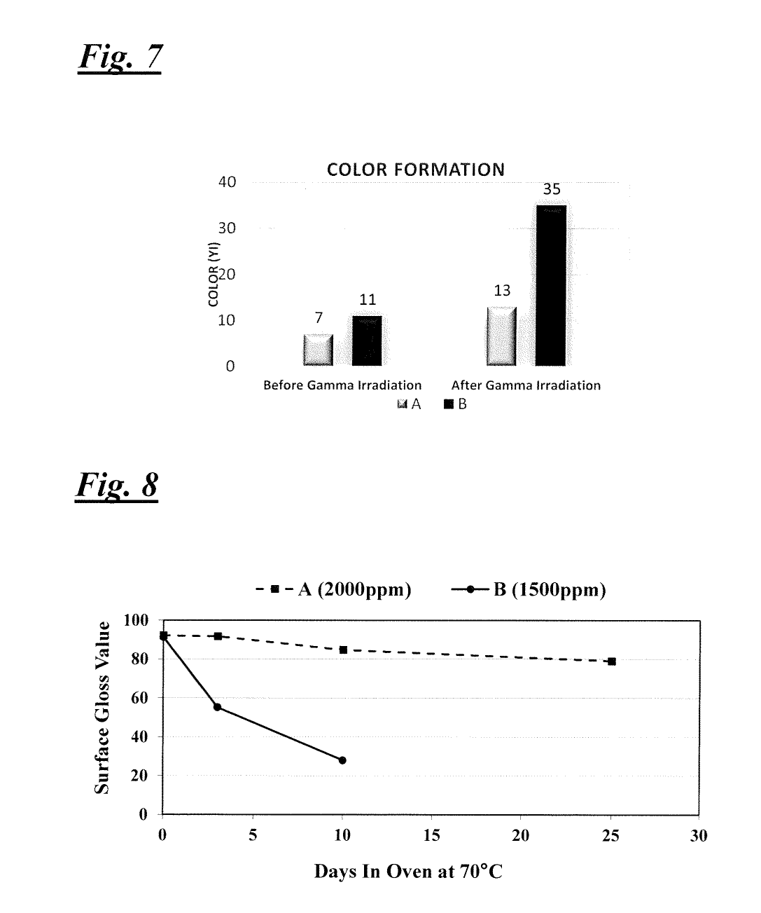

The performance of tris-di-tert-butyl phenol phosphite (commonly known as Irgafos® 168 or Doverphos® 480) was compared to a polymeric polyphosphite (Example #4) by compounding both into polypropylene and pressing the polymer into plaques. The plaques were exposed to 50 kilograys (kGy) of gamma irradiation. Color (YI) of the polymer was measured before and after exposure to the gamma irradiation. The color of the polymer containing the polymeric polyphosphite from Example #4, was far superior to the color of the polymer containing the tris-di-tert-butyl phenol phosphite. The color (YI) of the polymer containing the tris-di-tert-butyl phenol phosphite nearly tripled indicating a severe yellowing of the polymer whereas the polymeric polyphosphite sample only had a slight increase in color. (See FIG. 7 & Table VI)

TABLE VI

| | Before gamma | After gamma |
|---|---|---|
| Formulation in polypropylene | radiation | radiation |
| 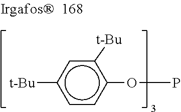 | 11 | 35 |
| polymeric CHDM polyphosphite | 7 | 13 |
| (Example #4) | | |

### Example 12

### Bloom Exudation

The compatibility of an additive in the polymer is a major factor when selecting the additive. Additives that are not compatible exude out of the polymer causing issues during processing and post processing. During processing additives that are not compatible will plate out on to the processing equipment which can cause delays in production since time must be taken to clean these additives off of the equipment. The time spent cleaning this equipment can be very costly since the equipment often needs to be shut down causing delays in production. Additives may also bloom to the surface of the polymer after processing. This can cause surface defects in the polymer, even causing a fine powder to develop if the additive is a solid.

The surface effects of the exuding additive can be measured by measuring the surface gloss of the polymer. The gloss reading of the surface will decrease as the amount of additive migrating to the surface increases.

Experiments were performed to compare a polymeric polyphosphite with tris-di-tert-butyl phosphite. These were compounded into LLDPE and compression molded into plaques. The polymeric polyphosphite was loaded into the polymer at a higher level to emphasize its superior compatibility in the polymer. The compression molded plaques were then aged in an oven at 70° C. to accelerate the possible migration of the additives. The surface gloss of the polymers was then measured at intervals over several weeks. This type of oven aging test is commonly used to measure the compatibility of additives in the polymer. It can accurately predict both plate out during processing and bloom post processing.

The surface gloss readings of the polymer containing 1500 ppm tris-di-tert-butylphenol phosphite dropped quickly indicating that the additive was exuding to the surface whereas the gloss readings for the polymeric phosphite remained constant indicating good compatibility despite the higher loading level. (See FIG. 8)

TABLE VII

| Formulation | Primary Antioxidant | Phosphite |
|---|---|---|
| A | 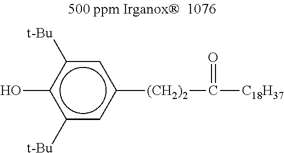 | 2000 ppm polymeric polyphosphite (Example #2) |
| B | 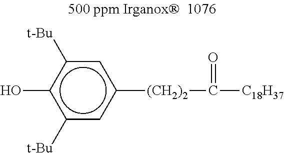 | 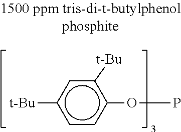 |

Increasing the level of the solid phosphite improves MI control. However, the solid phosphite tris-di-t-butylphenol phosphite (SP1) is known to have plate-out and bloom/exudation issues when used at levels >1000 ppm in certain LLDPE applications. Cast film is especially sensitive since resin is highly amorphous. High performance phosphites or primary antioxidants can be used to allow the level of SP1 to be reduced to minimize plate-out. However, the use of “anti-bloom” additives can reduce compatibility issues. Compounding LLDPE formulation in a Brabender-Bowl (torque rheometer) was followed by compression molding and quench cooling. This results in a highly amorphous LLDPE. Aging the compression molded plaques at 70° C. accentuates any potential of the additives to bloom. Bloom can be monitored by measuring the surface gloss. Surface gloss is reduced if an additive blooms. The composition of the bloom can be identified by surface ATR-FTIR.

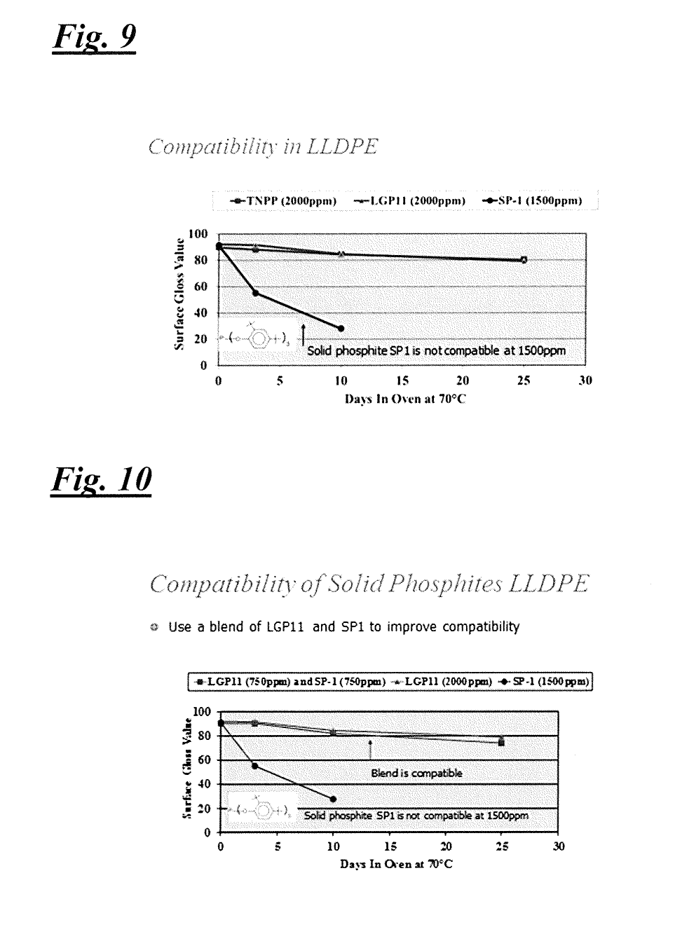

FIG. 9 shows that TNPP and polymeric polyphosphite (example #2) are very compatible even at 2000 ppm, but solid phosphite S1 (tris 2,4-di-tert-butylphenol phosphite) at 1500 ppm blooms. FIG. 10 shows that combining 750 ppm of solid S1 with 750 ppm of polymeric polyphosphite (example #2) and using as the stabilizer, results surprising show good compatibility.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process to improve the NOx stability of a polyolefin film wherein the Yellowness Index remains less than or equal to 18 after exposure to NOx at 50° C. for a minimum of 20 days, comprising the step of adding at least one homopolymer polyphosphite and copolymer polyphosphite of Formulas (I), (II) or (III) to the polyolefin: 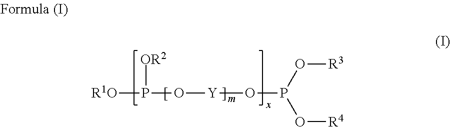
wherein in Formula (I)
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group; 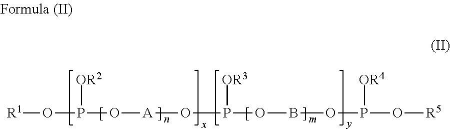
wherein in Formula (II)
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or Formula (III) 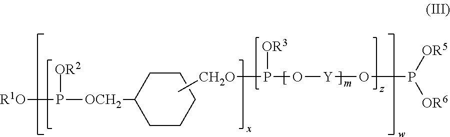
wherein in Formula (III)
each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

2. A process to improve the long term heat aging of a polyolefin film compared to the addition of tris-2,4-di-tert-butylphenol phosphite, comprising the step of adding at least one homopolymer polyphosphite and copolymer polyphosphite of Formulas (I), (II) or (Ill) to the polyolefin: 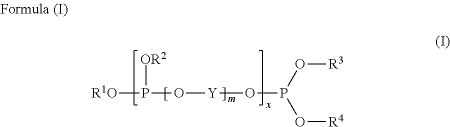
wherein in Formula (I)
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group; 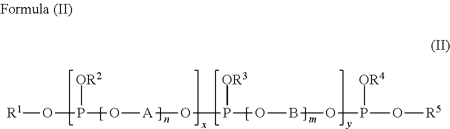
wherein in Formula (II)
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or Formula (III) 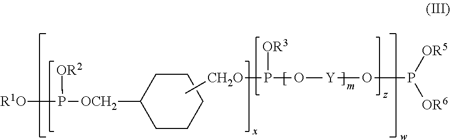
wherein in Formula (III)
each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

3. A process to reduce gel formation of a polyolefin film compared to the addition of tris(nonylphenyl)phosphite comprising the step of adding at least one homopolymer polyphosphite and copolymer polyphosphite of Formulas (I), (II) or (Ill) to the polyolefin: 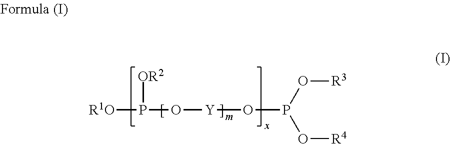
wherein in Formula (I)
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group; 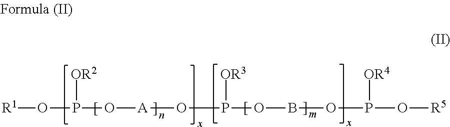
wherein in Formula (II)
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or Formula (III) 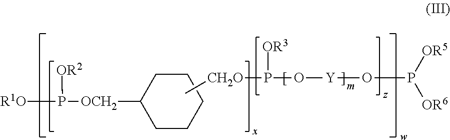
wherein in Formula (III)
each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

4. A process to improve the melt processing of a polyolefin film synergistically with the primary antioxidant Vitamin E, comprising the step of adding at least one homopolymer polyphosphite and copolymer polyphosphite of Formulas (I), (II) or (III) to the polyolefin: 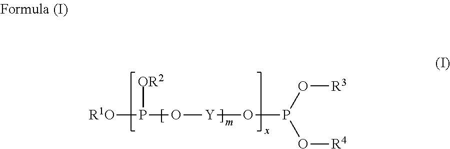
wherein in Formula (I)
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group; 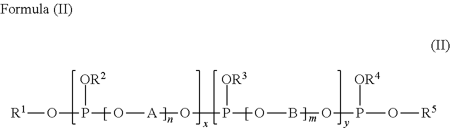
wherein in Formula (II)
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or Formula (III) 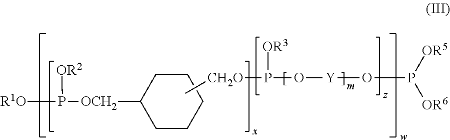
wherein in Formula (III)
each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

5. A process to improve the resistance of an antioxidant to migrate out to a surface of a polyolefin film compared to tris-nonylphenol phosphite or tris-2,4-di-tert-butylphenol phosphite comprising the step of adding at least one homopolymer polyphosphite and copolymer polyphosphite of Formulas (I), (II) or (Ill) to the polyolefin: 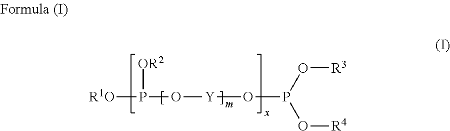
wherein in Formula (I)
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group; 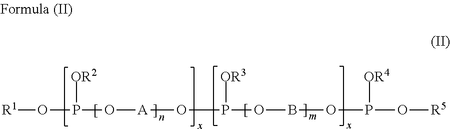
wherein in Formula (II)
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or Formula (III) 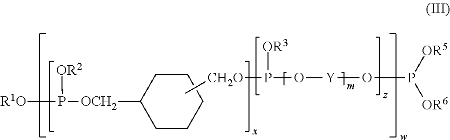
wherein in Formula (III)
each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

6. A process to improve the Yellowness Index of a polyolefin film when exposed to gamma irradiation in comparison to the addition of tris-di-tert-butyl phenol phosphite, comprising the step of adding at least one homopolymer polyphosphite and copolymer polyphosphite of Formulas (I), (II) or (III) to the polyolefin: 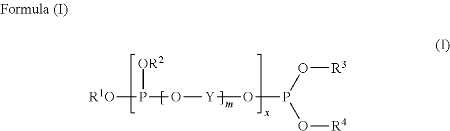
wherein in Formula (I)
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group; 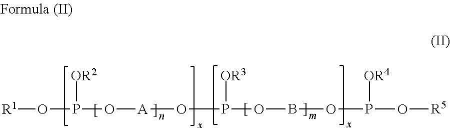
wherein in Formula (II)
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or Formula (III) 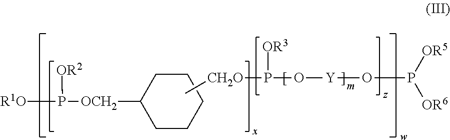
wherein in Formula (III)
each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

7. A process to reduce the bloom exudation of a polyolefin film in comparison to the addition of tris-di-tert-butylphenol phosphite comprising the step of adding at least one homopolymer polyphosphite and copolymer polyphosphite of Formulas (I), (II) or (Ill) to the polyolefin: 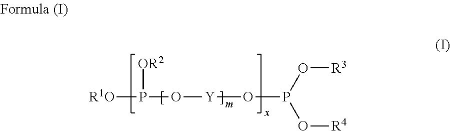
wherein in Formula (I)
each R¹, R², R³ and R⁴ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group; 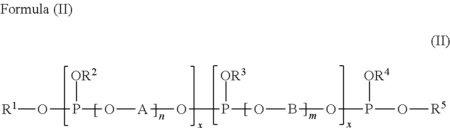
wherein in Formula (II)
each R¹, R², R³, R⁴ and R⁵ can be the same or different and independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁵)—R⁹— wherein R⁷, R⁵ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or Formula (III) 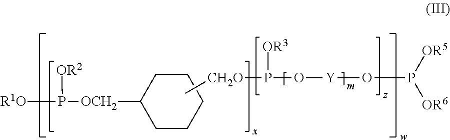
wherein in Formula (III)
each R¹, R², R³, R⁴, R⁵ and R⁶ can be the same or different and independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).
